(19) United States
(12) Patent Application Publication
(10) Pub. No.: US 2015/0067378 A1
(43) Pub. Date: Mar. 5, 2015

(54) MEASURING APPARATUS, MEASURING METHOD, AND MEASURING SYSTEM

(71) Applicant: FUJITSU LIMITED, Kawasaki-shi (JP)

(72) Inventor: Takahiro KOBAYASHI, Hakui (JP)

(73) Assignee: FUJITSU LIMITED, Kawasaki-shi (JP)

(21) Appl. No.: 14/286,121

(22) Filed: May 23, 2014

(30) Foreign Application Priority Data
Aug. 30, 2013 (JP) 2013-179993

(51) Int. Cl. G06F 1/26

(52) U.S. Cl. CPC G06F 1/26
USPC 713/340

(57) ABSTRACT

A measuring apparatus, includes: a switch configured to short-circuit, among a plurality of power supply lines on a print board, second power supply lines other than a first power supply line to be measured and short-circuit with a ground; and an ohmmeter configured to measure a first resistance value between the first power supply line and the ground.

### CROSS-REFERENCE TO RELATED APPLICATION

This application is based upon and claims the benefit of priority of the prior Japanese Patent Application No. 2013-179993, filed on Aug. 30, 2013, the entire contents of which are incorporated herein by reference.

### FIELD

Embodiments discussed herein are related to measuring apparatuses, measuring methods, and measuring systems.

### BACKGROUND

With enhanced power saving in information processing apparatuses, voltages of power supplies to be used in print boards are being reduced, and the types of a power supply to be supplied to mounted circuit components are increasing. With a print board for an information processing apparatus, a short circuit check between a power supply line and a ground (hereinafter, between V and G) and a short circuit check between different types of power supply lines (hereinafter, between V and V) are carried out.

Related arts are disclosed in Japanese Laid-open Patent Publication No. 1-308975 (Japanese Examined Patent Application Publication No. 7-78514).

### SUMMARY

According to one aspect of the embodiments, a measuring apparatus, includes: a switch configured to short-circuit, among a plurality of power supply lines on a print board, second power supply lines other than a first power supply line to be measured and short-circuit with a ground; and an ohmmeter configured to measure a first resistance value between the first power supply line and the ground.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A, FIG. 1B, and FIG. 1C illustrate an example of a short circuit check;

FIG. 2A and FIG. 2B illustrate an example of a measuring method;

FIG. 3A and FIG. 3B illustrate an example of a measuring method;

FIG. 4A and FIG. 4B illustrate an example of a measuring method;

FIG. 5A and FIG. 5B illustrate an example of a measuring method;

FIG. 6A to FIG. 6D illustrate an example of a low resistance V-G determination;

FIG. 7 illustrates an example of a low resistance V-G determination;

FIG. 8 illustrates an example of a low resistance VG determination flow;

FIG. 9 illustrates an example of a graph of V-I characteristics;

FIG. 10 illustrates an example of a low resistance VG check;

FIG. 11 illustrates an example of a measuring method;

FIG. 12 illustrates an example of a measuring method;

FIG. 13A to FIG. 13D illustrate an example of defective product processing;

FIG. 14 illustrates an example of a measuring apparatus;

FIG. 15 illustrates an example of processing of a measuring apparatus;

FIG. 16 illustrates an example of processing of a measuring apparatus;

FIG. 17 illustrates an example of a defective product processing; and

FIG. 18 illustrates an example of a defective product processing.

### DESCRIPTION OF EMBODIMENTS

In a case in which all of the combinations of V and G, and V and V are checked in order to ensure short circuit checks on a large number of power supply types, an operation amount and a testing hour increase.

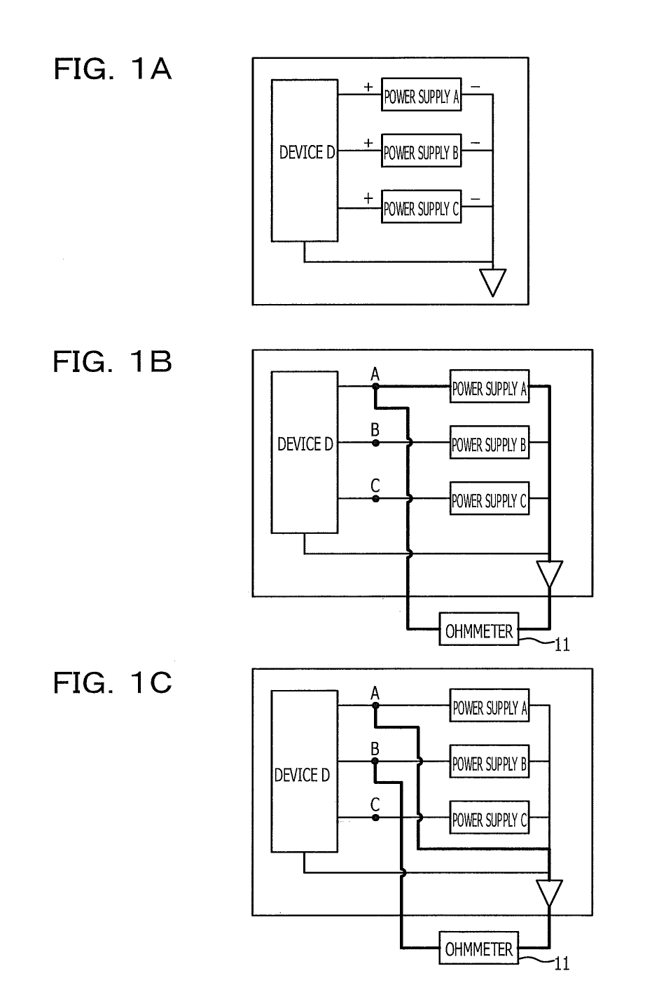

FIG. 1A, FIG. 1B, and FIG. 1C illustrate an example of a short circuit check. In FIG. 1A, FIG. 1B, and FIG. 1C, a short circuit check between V and G and a short circuit check between V and V are illustrated. The term between V and G corresponds to between a positive side of a power supply and a negative side of the power supply across internal resistance thereof. The term between V and V corresponds to between a positive side of a power supply and a positive side of another power supply. FIG. 1A illustrates three power supplies A to C and a device D mounted on a print board. The device D is provided on power supply lines of the power supplies A to C, and each of the power supplies A to C supplies electric power independently to the device D through the power supply line. The device D is grounded. A power supply line corresponds to a line extending from a positive side of a power supply to a load.

FIG. 1B illustrates a short circuit check between V and G on the power supply line of the power supply A. As illustrated in FIG. 1B, the resistance between a terminal A, which is located between the positive side of the power supply A and the device D, and the ground is measured with an ohmmeter 11. Thus, a short circuit check between V and G on the power supply line of the power supply A is carried out. In order to carry out a short circuit check between V and G on the power supply line of the power supply B, the resistance between a terminal B, which is located between the positive side of the power supply B and the device D, and the ground is measured with the ohmmeter 11. In order to carry out a short circuit check between V and G on the power supply line of the power supply C, the resistance between a terminal C, which is located between the positive side of the power supply C and the device D, and the ground is measured with the ohmmeter 11. Short circuit checks in a number corresponding to the number of power supply lines are carried out.

FIG. 1C illustrates a short circuit check between V and V on the power supply line of the power supply A and the power supply line of the power supply B. As illustrated in FIG. 1C, the resistance between the terminal A and the terminal B is measured with the ohmmeter 11. In order to carry out a short circuit check between V and V on the power supply line of the power supply B and the power supply line of the power supply C, the resistance between the terminal B and the terminal C is measured with the ohmmeter 11. In order to carry out a short circuit check between the power supply line of the power supply C and the power supply line of the power supply A, the resistance between the terminal C and the terminal A is measured with the ohmmeter 11. When the number of the power supply lines is represented by N, _{N}C₂ patterns of short circuit checks are carried out.

With a print board that includes N power supply lines, (N+_{N}C₂) patterns of resistance measurement are carried out in order to carry out short circuit checks between V and G and short circuit checks between V and V on all of the power supply lines. For example, when N=3, the resistance measurement is carried out six times. For example, when N=10, the resistance measurement is carried out 55 times. For example, when N=26, the resistance measurement is carried out 351 times. The operation amount and the test time increase.

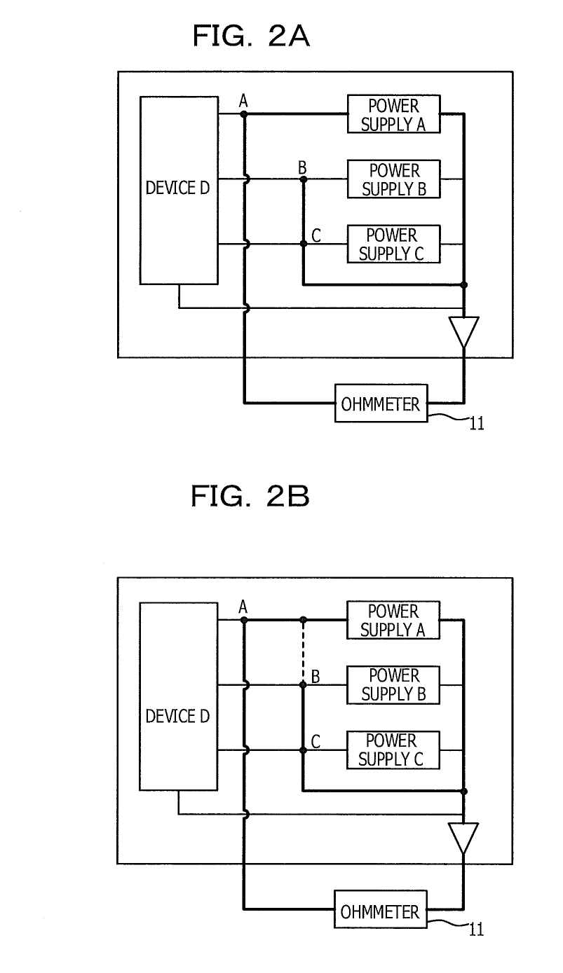

FIG. 2A and FIG. 2B illustrate an example of a measuring method. In FIG. 2A, three power supplies, for example the power supplies A to C, are mounted on a print board. The device D is provided on the power supply lines of the power supplies A to C. Each of the power supplies A to C supplies electric power independently to the device D through the power supply line. The device D is grounded. As illustrated in FIG. 2A, a resistance value between the terminal A and the ground is detected by using the ohmmeter 11, and thus a short circuit check on the power supply line of the power supply A is carried out. At this time, the power supply lines of the power supply B and the power supply C, excluding the power supply A, are short-circuited with each other and are then short-circuited with a ground line. For example, the terminal B, the terminal C, and the ground are short-circuited.

In a case in which a short circuit has occurred between V and G on the power supply line of the power supply A, the resistance value between V and G on the power supply line of the power supply A decreases, and thus a short-circuited state is detected. As illustrated in FIG. 2B, in a case in which a short circuit has occurred between the power supply line of the power supply A and the power supply line of the power supply B, the resistance between V and G on the power supply line of the power supply A is short-circuited to the ground through the terminal A, the terminal B, and the terminal C, and thus the resistance value detected by the ohmmeter 11 becomes zero. Consequently, a short circuit between V and V is detected. In a case in which a short circuit has occurred between the power supply line of the power supply A and the power supply line of the power supply C as well, in a similar manner, the resistance between V and G on the power supply line of the power supply A is short-circuited to the ground through the terminal C, and thus the resistance value detected by the ohmmeter 11 becomes zero. In this manner, since all of the power supply lines, except for the power supply line of the power supply A, are grounded, the presence of a short circuit between V and V on the other power supply lines is detected.

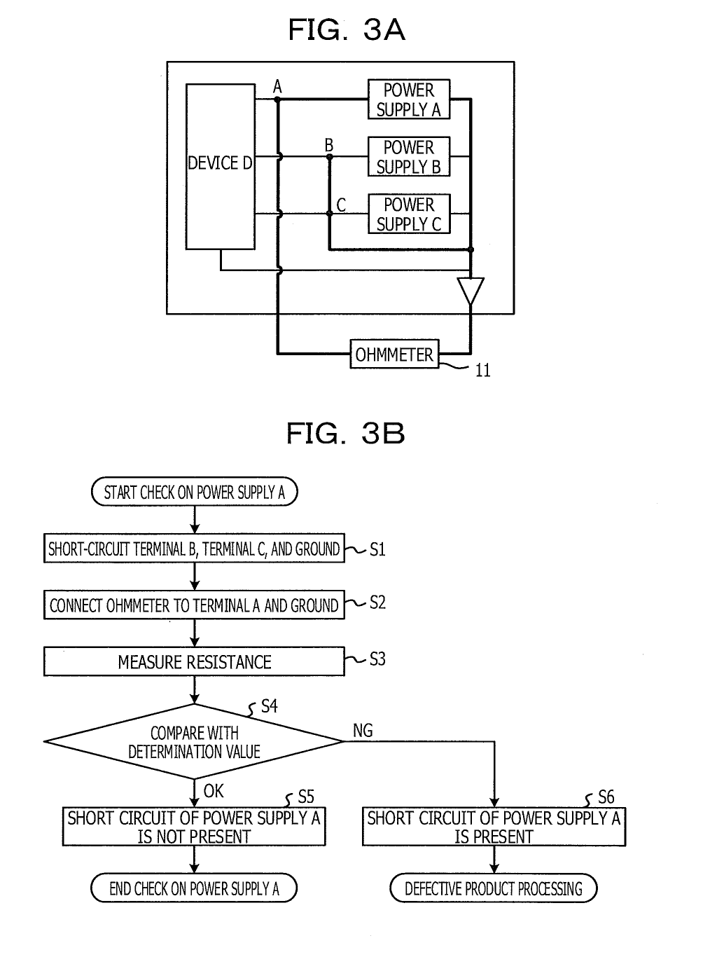

FIG. 3A and FIG. 3B illustrate an example of a measuring method. FIG. 3B illustrates a flow of a short circuit check on the power supply line of the power supply A. As illustrated in FIG. 3A, the terminal B, the terminal C, and the ground are short-circuited (operation S1). The ohmmeter 11 is coupled to the terminal A and the ground (operation S2). The resistance value is measured by using the ohmmeter 11 (operation S3). The resistance value measured in operation S3 (measured resistance value) is compared with a determination value (operation S4). If the measured resistance value is equal to or greater than the determination value, it is determined that a short circuit is not present on the power supply line of the power supply A (operation S5), and the check on the power supply A is terminated. If the measured resistance value is less than the determination value, it is determined that a short circuit is present on the power supply line of the power supply A (operation S6), and defective product processing is carried out.

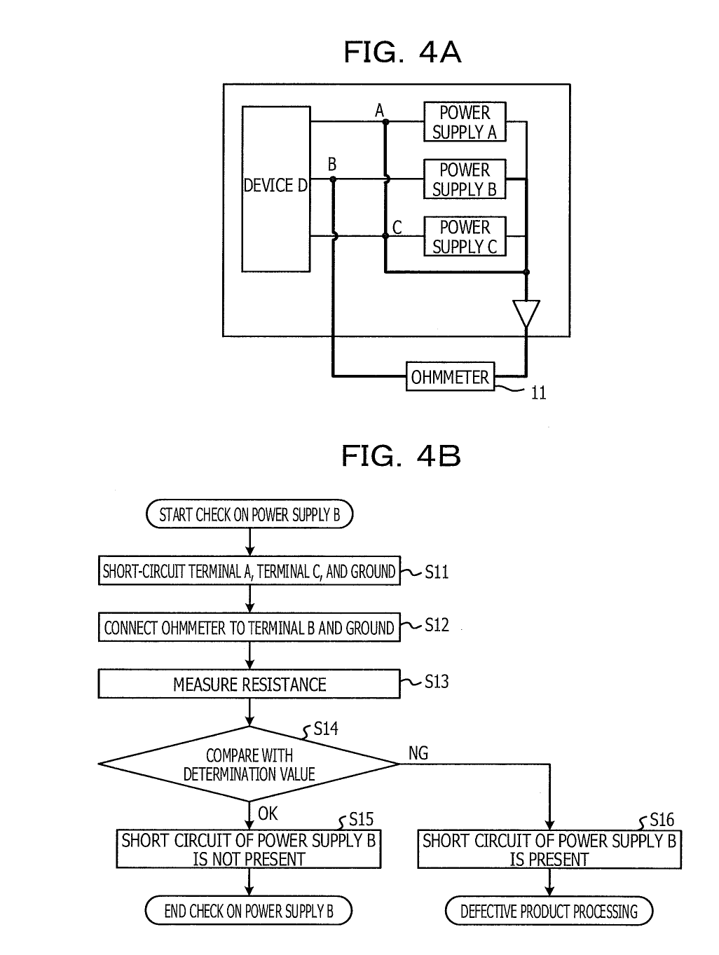

FIG. 4A and FIG. 4B illustrate an example of a measuring method. FIG. 4B illustrates a flow of a short circuit check on the power supply line of the power supply B. As illustrated in FIG. 4A, the terminal A, the terminal C, and the ground are short-circuited (operation S11). The ohmmeter 11 is coupled to the terminal B and the ground (operation S12). The resistance value is measured by using the ohmmeter 11 (operation S13). The resistance value measured in operation S13 (measured resistance value) is compared with the determination value (operation S14). If the measured resistance value is equal to or greater than the determination value, it is determined that a short circuit is not present on the power supply line of the power supply B (operation S15), and the check on the power supply B is terminated. If the measured resistance value is less than the determination value, it is determined that a short circuit is present on the power supply line of the power supply B (operation S16), and the defective product processing is carried out.

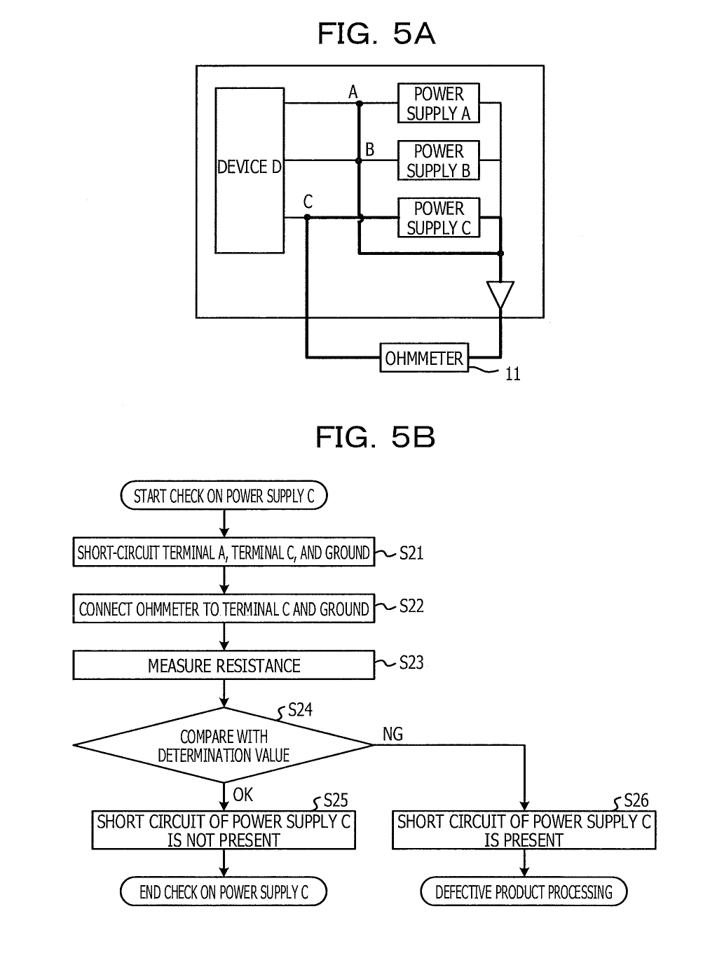

FIG. 5A and FIG. 5B illustrate an example of a measuring method. FIG. 5B illustrates an example of a flow of a short circuit check on the power supply line of the power supply C. As illustrated in FIG. 5A, the terminal A, the terminal B, and the ground are short-circuited (operation S21). The ohmmeter 11 is coupled to the terminal C and the ground (operation S22). The resistance value is measured by using the ohmmeter 11 (operation S23). The resistance value measured in operation S23 (measured resistance value) is compared with the determination value (operation S24). If the measured resistance value is equal to or greater than the determination value, it is determined that a short circuit is not present on the power supply line of the power supply C (operation S25), and the check on the power supply C is terminated. If the measured resistance value is less than the determination value, it is determined that a short circuit is present on the power supply line of the power supply C (operation S26), and the defective product processing is carried out.

According to the measuring method described above, when a short circuit check is carried out on a specific power supply line mounted on a print board, the specific power supply line is short-circuited with the ground after all of the other power supply lines are short-circuited, and thus a short circuit check between V and G and a short circuit check between V and V are carried out in a fewer operations. Accordingly, a power supply short circuit check may be carried out with ease. For example, when the number of power supply lines on a print board is represented by N, the resistance measurement may be carried out N+_{N}C₂ times with the measuring method illustrated in FIG. 1A to FIG. 1C. With the measuring method illustrated in FIG. 2A to FIG. 5B, the resistance measurement may be carried out N times. For example, when N=3, the resistance measurement is carried out three times in contrast to N+_{N}C₂=6 times, and thus three instances of the resistance measurement are cut back. For example, when N=10, the resistance measurement is carried out 10 times in contrast to N+_{N}C₂=55 times, and thus 45 instances of the resistance measurement are cut back. For example, when N=26 (an example of a server type motherboard), the resistance measurement is carried out 26 times in contrast to N+_{N}C₂=351 times, and thus 325 instances of the resistance measurement are cut back.

With increased operation speed and miniaturization of semiconductor devices, leakage currents in various semiconductor devices, such as an MPU, a CPU, or an FPGA, may increase. Thus, the resistance value between V and G in a semiconductor device may decrease. Variations among individual products may make it harder to measure a short circuit in a power supply, for example, to determine the quality of the power supply. Thus, as the determination on a mounted device having a large leakage current is made in a stable manner, a yield may improve, and the distribution of defective products may be suppressed.

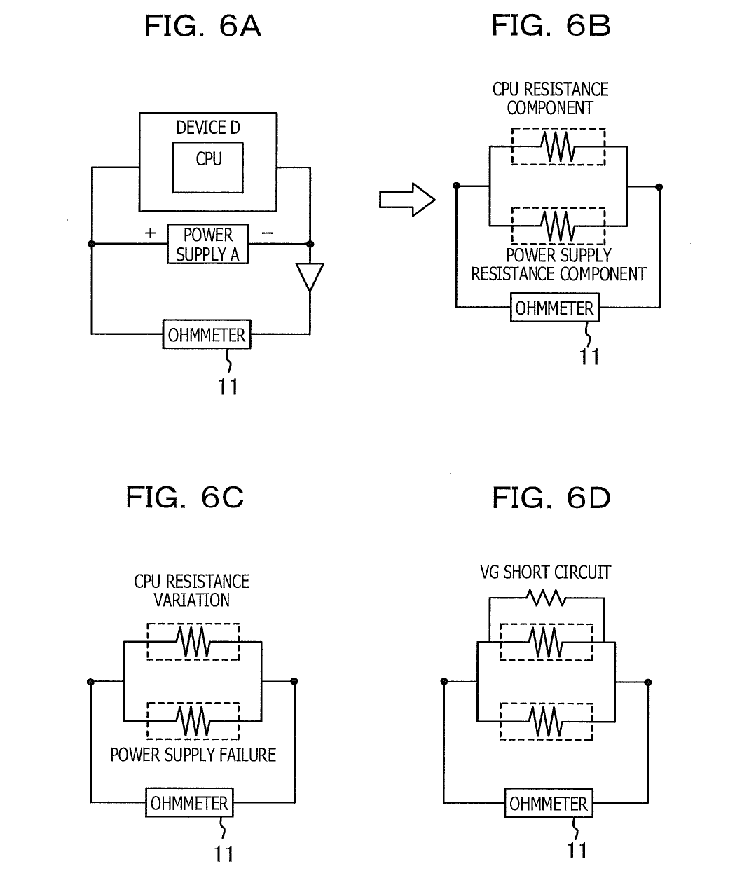

FIG. 6A to FIG. 6D illustrate an example of a low resistance V-G determination. FIG. 6A illustrates an example of a power supply and a device to be mounted on a print board. In FIG. 6A, the power supply A and the device D are mounted on the print board. For example, the device D may be a CPU. The device D is provided on the power supply line of the power supply A. The power supply A supplies electric power to the device D. The device D is grounded. In FIG. 6A, the resistance between V and G may be measured by measuring the resistance in a parallel connection of a CPU resistance component and a power supply resistance component, as illustrated in FIG. 6B. In a case in which a leakage current of the CPU is large, the CPU resistance component is considerably small, and a variation is large, the following problem may arise.

As illustrated in FIG. 6C, a measured resistance value varies due to an individual difference of CPUs, and thus it may be difficult to make a determination with the use of a fixed threshold value. It may be difficult to determine whether short circuit failure has occurred or the variation in the CPU resistance value is the cause. When the threshold value is loose, short circuit failure may be distributed. When the threshold value is strict, a nonadjusted ratio due to false detection may decrease. As illustrated in FIG. 6C, in a case in which a resistance component of the power supply side has decreased due to power supply circuit failure, it may be difficult to determine whether or not the measured resistance value has decreased due to a variation in the CPU resistance component. The power supply failure may be distributed. As illustrated in FIG. 6D, when the resistance at the CPU side is considerably small, the presence of a short circuit may not be detected. The resistance between V and G in a state in which there is a short circuit between V and G by soldering may not become zero because there is some resistance component due to a short circuit by soldering, a wiring resistance component, and so on. In the resistance measurement, it may be difficult to differentiate between the case of a power supply short circuit and the case in which the CPU resistance component is considerably small. For example, short circuit failure (burning) may be distributed, and a BGA component may be removed and inspected.

The resistance value between V and G in a device having a large leakage current is considerably small (for example, 1Ω or less), and an individual variation among the devices is large as well (for example, several hundred mΩ to several Ω). In this case, if a short circuit check between V and G is carried out by measuring the resistance between V and G with the use of a fixed threshold value so as to carry out a quality determination, a false determination may be made, and a defective product may be distributed, leading to a decrease in the yield or to an inspection of a false detection production. In a case in which the resistance value between V and G in a device is considerably small, it may be difficult to carry out measurement or to determine whether a power supply short circuit is present.

In a case in which the resistance value between v and G in a device mounted on a print board is small or varies among devices, a power supply short circuit check may be carried out in a stable manner.

For example, based on the resistance value of a device alone of which a leakage current measured in advance is large and a variation is large, a determination value of the resistance between V and G is individually set for a plurality of devices to be mounted on a print board, and the determination is carried out.

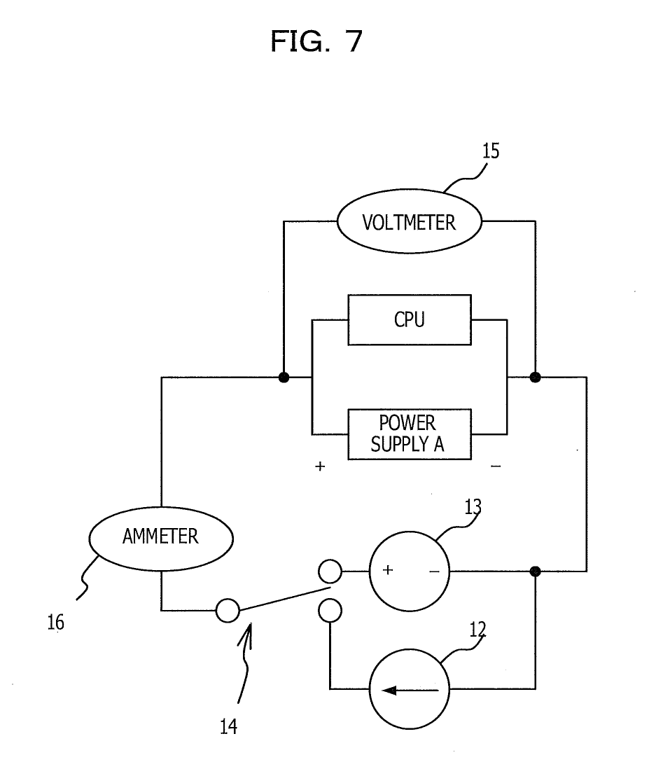

FIG. 7 illustrates an example of a low resistance V-G determination. Electric power is supplied between two points, for example, one point at a one side of the power supply A and the device D (CPU) and the other point at the other side therebetween, from a direct current constant current source 12 or a direct current constant voltage source 13 by using a switch 14. A voltage value between the two points is measured by using a voltmeter 15. A current value between the two points is measured by using an ammeter 16.

The power supply is supplied from the direct current constant voltage source 13, and the current flowing between the two points is measured by using the ammeter 16. The power supply is then supplied from the direct current constant current source 12, and the voltage value between the two points is measured by using the voltmeter 15. It is determined whether or not the measured current value and the measured voltage value satisfy reference values, and thus a short circuit between V and G on a print board on which a low resistance device is mounted is detected. The determination of the presence of a short circuit between V and G based on each of the measured voltage value and the measured current value may be made based on a difference between the V-I characteristics of the time when a short circuit between V and G is not present and the V-I characteristics of the time when a short circuit between V and G is present.

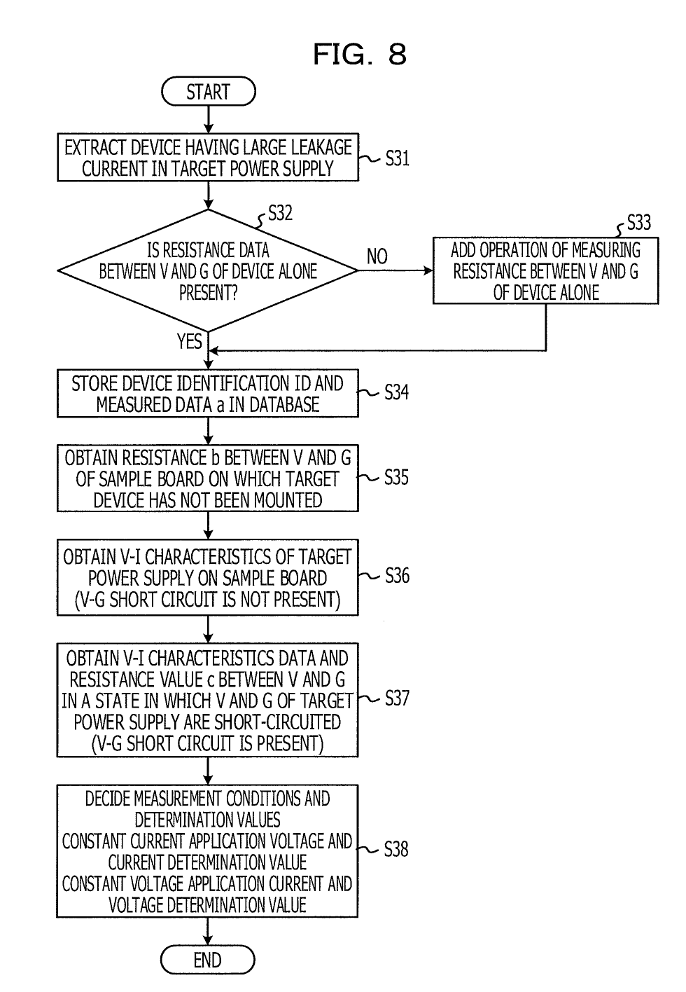

FIG. 8 illustrates an example of a low resistance V-G determination flow. For example, a VG determination value corresponding to a device that is mounted on a print board and has a large leakage current, such as an LSI, is individually set in advance. As illustrated in FIG. 8, in a target power supply for the low resistance VG determination, a device that has a large leakage current and that causes the resistance value between V and G to reduce is extracted (operation S31). It is determined whether or not data on the resistance between V and G of the device alone, which has a large leakage current, is present (operation S32). If it is determined to be “No” in operation S32, an operation of measuring the resistance between V and G of the device alone, which has a large leakage current, is added (operation S33). If it is determined to be “Yes” in operation S32 or after operation S33 is carried out, the measured resistance between V and G (hereinafter, measured data a) measured through the operation of inspecting the device alone, which has a large leakage current, is associated with a device identification ID and stored in a database (operation S34).

The resistance between V and G (hereinafter, resistance b between V and G) of a sample board on which a target device has not been mount is obtained (operation S35). The V-I characteristics of the target power supply on the sample board while a short circuit between V and G is not present is obtained (operation S36). The V-I characteristics data and the resistance between V and G (hereinafter, resistance c between V and G) in a state in which V and G of the target power supply is short-circuited are obtained (operation S37). An applied voltage of a constant current power supply and a current determination value (hereinafter, data d) are decided, and an applied current of a constant voltage power supply and a voltage determination value (hereinafter, data e) are decided (operation S38).

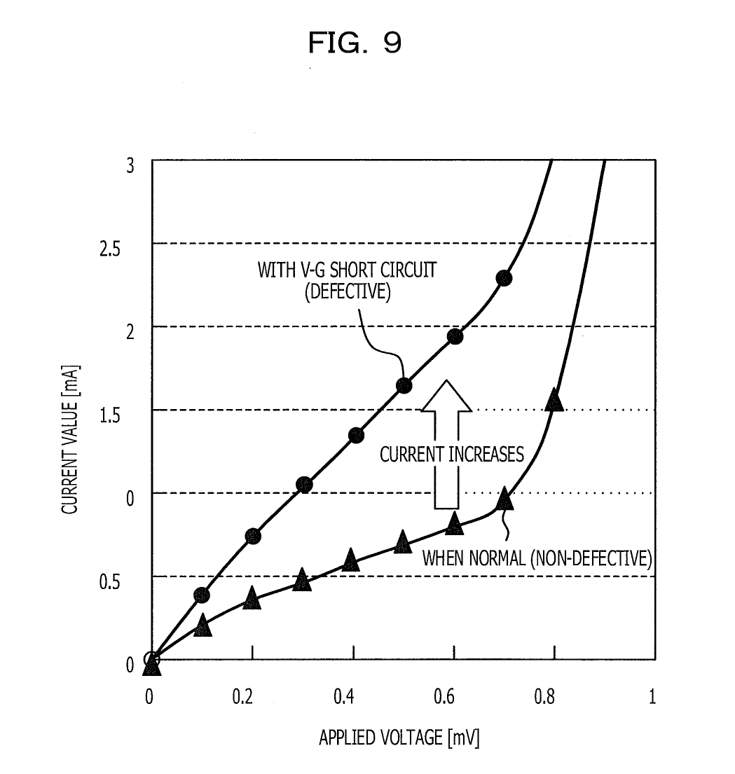

FIG. 9 illustrates an example of a graph of the V-I characteristics. A curve connecting the triangles indicates a case of a non-defective product in which a short circuit between V and G is not present, a leakage current of a mounted device is large and the resistance between V and G is low. A curve connecting the filled circles indicates a case of a defective product in which a short circuit between V and G is present. When the V-I characteristics of the two are compared, in a case in which constant current/constant voltage power supplies that are smaller than a rated power supply voltage are applied, a large current flows, for example, through a portion of a short circuit by soldering when a short circuit between V and G is present. In the case of the non-defective product, a current flows through a semiconductor inside the device. Thus, under the condition of the time when a minute voltage is applied, a current value is smaller than that in a case of a short circuit by soldering. The quality determination is made based on a difference in a current value produced when a voltage is applied. The measurement conditions (applied voltage/current) and the determination values are determined based on the stated data.

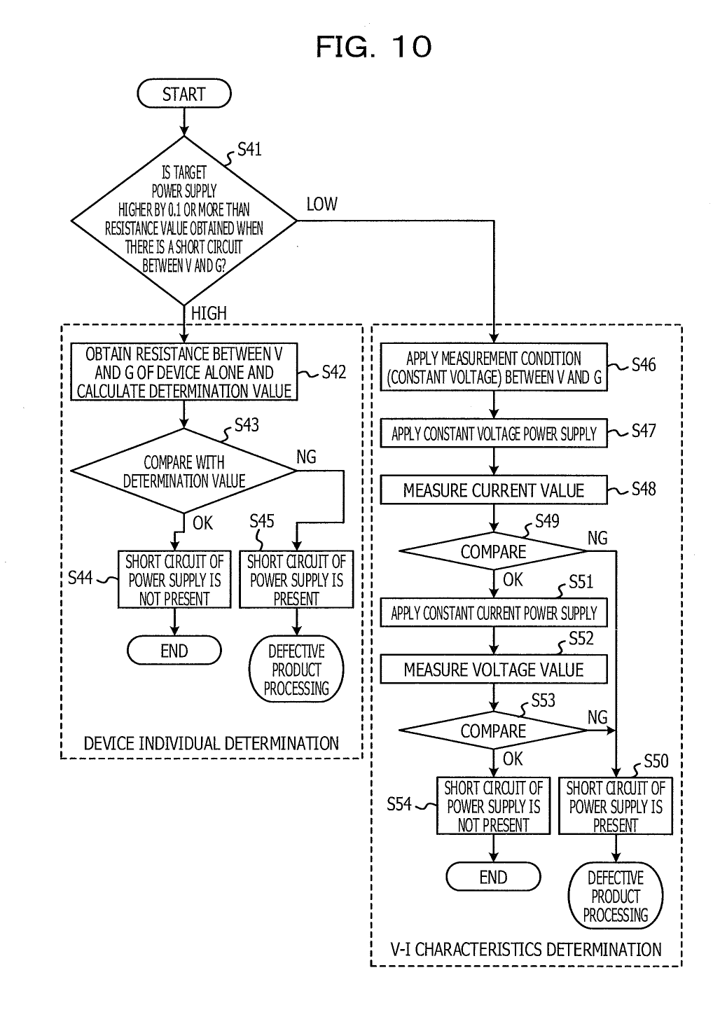

FIG. 10 illustrates an example of a low resistance VG check. It is determined whether or not a target power supply for the low resistance VG check is higher by 0.1Ω or more than the result of the resistance (measured resistance) between V and G measured through the measuring method illustrated in FIG. 3A to FIG. 5B (operation S41). If it is determined to be higher in operation S41, a device individual determination is carried out. The measurement data a of the device alone is obtained based on the mounted device identification ID, and the determination value is calculated (operation S42). The determination value may be calculated based on the parallel combined resistance of the measurement data a and the resistance b between V and G. The measured resistance obtained in operation S41 is compared with the stated determination value (operation S43). If the measured resistance is equal to or greater than the determination value, it may be determined that a short circuit of the power supply is not present (operation S44). If the measured resistance is less than the determination value, it is determined that a short circuit of the power supply is present (NG) (operation S45), and defective product processing is carried out.

If it is determined to be lower in operation S41, a V-I characteristics determination is carried out. The constant voltage of the measurement condition is applied between V and G (operation S46). The constant current power supply applied voltage of the data d is applied by using the direct current constant voltage source 13 (operation S47). The current value between V and G is measured by using the ammeter 16 (operation S48). The current value measured in operation S48 is compared with the current determination value of the data d (operation S49). If the measured current value is equal to or greater than the current determination value in operation S49, it is determined that a short circuit of the power supply is present (NG) (operation S50), and the defective product processing is carried out.

If the measured current value is less than the current determination value in operation S49, the constant voltage power supply applied current of the data e is applied by using the direct current constant current source 12 (operation S51). The voltage value between V and G is measured by using the voltmeter 15 (operation S52). The voltage value measured in operation S52 is compared with the voltage determination value of the data e (operation S53). If the measured voltage value is equal to or less than the voltage determination value in operation S53, it is determined that a short circuit of the power supply is present (NG) (operation S50), and the defective product processing is carried out. If the measured voltage value is greater than the voltage determination value in operation S53, it is determined that a short circuit of the power supply is not present (operation S54).

With the processing illustrated in FIG. 10, even if the resistance value between V and G in a device mounted on a print board is small or varies among devices, the power supply short circuit check may be carried out in a stable manner.

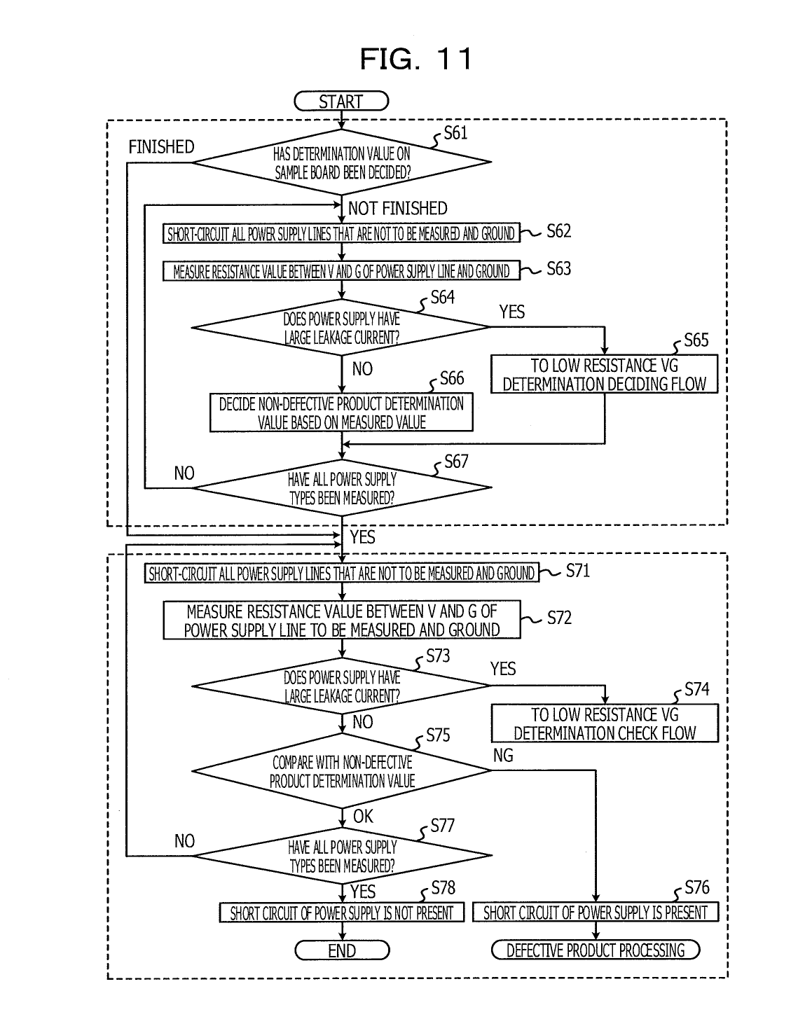

FIG. 11 illustrates an example of a measuring method. The flow illustrated in FIG. 11 includes a determination value deciding processing flow (S61 to S67) and a short circuit check flow (S71 to S78). The short circuit check flow is carried out after the determination value deciding processing flow. It is determined whether or not the determination value has been decided on a sample board that has been found in advance to be a non-defective product (operation S61). If it is determined to be “No” in operation S61, power supply lines that are not to be measured and the ground are short-circuited on the sample board (operation S62). The V-G resistance value between the power supply line to be measured and the ground is measured (operation S63).

Based on the measurement result in operation S63, it is determined whether or not the leakage current is large by using the certain determination value (operation S64). If it is determined to be “Yes” in operation S64, the processing illustrated in FIG. 8 is carried out (operation S65). If it is determined to be “No” in operation S64, a non-defective product determination value is decided based on the measured value in operation S63 (operation S66). It is determined whether or not all of the power supply lines have been measured (operation S67). If it is determined to be “No” in operation S67, the processing is carried out again, starting from operation S62, on another power supply line. If it is determined to be “Yes” in operation S61, or if it is determined to be “Yes” in operation S67, the short circuit check flow is started.

In the print board to be measured, power supply lines that are not to be measured and the ground are short-circuited (operation S71). The V-G resistance between the power supply line to be measured and the ground is measured (operation S72). Based on the measurement result in operation S72, it is determined whether or not the leakage current is large by using the certain determination value (operation S73). If it is determined to be “Yes” in operation S73, the flowchart illustrated in FIG. 10 is carried out (operation S74). If it is determined to be “No” in operation S73, it is determined whether or not the measured resistance value in operation S72 is equal to or greater than the non-defective product determination value decided through the determination value deciding processing flow (operation S75).

If it is determined to be “No” in operation S75, it is determined that a short circuit of the power supply is present (NG) (operation S76), and the defective product processing is carried out. If it is determined to be “Yes” in operation S75, it is determined whether or not all of the power supply lines on the print board to be measured have been measured (operation S77). If it is determined to be “No” in operation S77, the processing is carried out again, starting from operation S71, on another power supply line. If it is determined to be “Yes” in operation S77, it may be determined that a short circuit of the power supply is not present (operation S78).

With the flowchart illustrated in FIG. 11, when a short circuit check is carried out on a specific power supply mounted on the print board, all of the remaining power supplies are short-circuited with the ground, and thus a short circuit check between V and G and a short circuit check between V and V may be carried out in a fewer operations. The power supply short circuit check may be carried out with ease. In a case in which the V-G resistance value of a device mounted on a print board is small or varies among devices, the power supply short circuit check may be carried out in a stable manner.

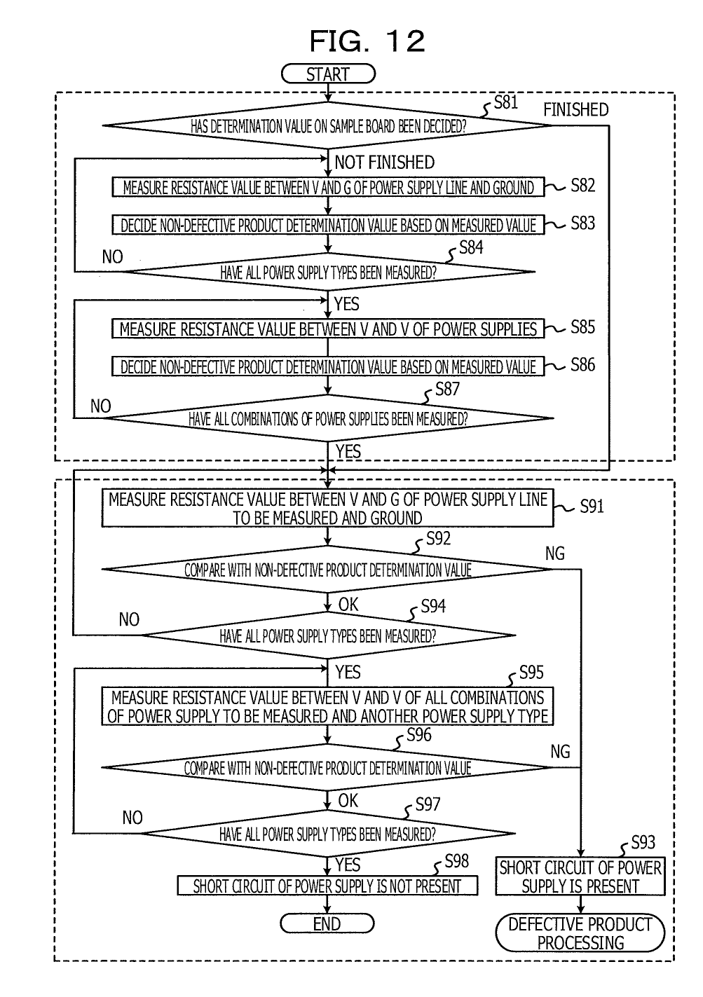

FIG. 12 illustrates an example of a measuring method. As illustrated in FIG. 12, the entire flow includes a determination value deciding processing flow (S81 to S87) and a short circuit check flow (S91 to S98). The short circuit check flow is carried out after the determination value deciding processing flow. It is determined whether or not the determination value has been decided on a sample board that has been found in advance to be a non-defective product (operation S81). If it is determined to be “No” in operation S81, the V-G resistance value between the power supply line to be measured and the ground is measured (operation S82).

The non-defective product determination value of the resistance between V and G is decided based on the measured value in operation S82 (operation S83). It is determined whether or not all of the power supply lines have been measured (operation S84). If it is determined to be “No” in operation S84, the processing is carried out again, starting from operation S82, on another power supply line. If it is determined to be “Yes” in operation S84, the resistance value between V and V of the power supplies is measured (operation S85). The non-defective product determination value of the resistance between V and V is decided based on the measured value in operation S85 (operation S86). It is determined whether or not the resistance value between V and V has been measured for all of the combinations of the power supplies (operation S87). If it is determined to be “No” in operation S87, the processing is carried out again, starting from operation S85, on another combination of power supplies. If it is determined to be “Yes” in operation S81, or if it is determined to be “Yes” in operation S87, the short circuit check flow is started.

On the print board to be measured, the resistance between V and G of the power supply line to be measured and the ground is measured (operation S91). It is determined whether or not the measured resistance value in operation S91 is equal to or greater than the non-defective product determination value decided in operation S83 (operation S92). If it is determined to be “No” in operation S92, it is determined that a short circuit of the power supply is present (operation S93), and the defective product processing is carried out. If it is determined to be “Yes” in operation S92, it is determined whether or not all of the power supply lines on the print board to be measured have been measured (operation S94). If it is determined to be “No” in operation S94, the processing is carried out again, starting from operation S91, on another power supply line.

If it is determined to be “Yes” in operation S94, the resistance value between V and V is measured for all of the combinations of a power supply line to be measured and another power supply line on the print board to be measured (operation S95). It is determined whether or not the measured resistance value in operation S95 is equal to or greater than the non-defective product determination value decided in operation S86 (operation S96). If it is determined to be “No” in operation S96, it is determined that a short circuit of the power supply is present (operation S93), and the defective product processing is carried out. If it is determined to be “Yes” in operation S96, it is determined whether or not all of the power supply lines have been measured (operation S97). If it is determined to be “No” in operation S97, the processing is carried out again, starting from operation S95, on another power supply line. If it is determined to be “Yes” in operation S97, it may be determined that a short circuit of the power supply is not present (operation S98).

According to the measuring method illustrated in FIG. 12, with a print board that includes N power supply lines, a short circuit check between V and G and a short circuit check between V and V are carried out for all of the power supply lines, and thus (N+_{N}C₂) patterns of the resistance measurement are carried out. Thus, an operation amount may increase. In a case in which the resistance value between V and G of a device mounted on a print board is small or varies among devices, the power supply short circuit check may not be carried out in a stable manner.

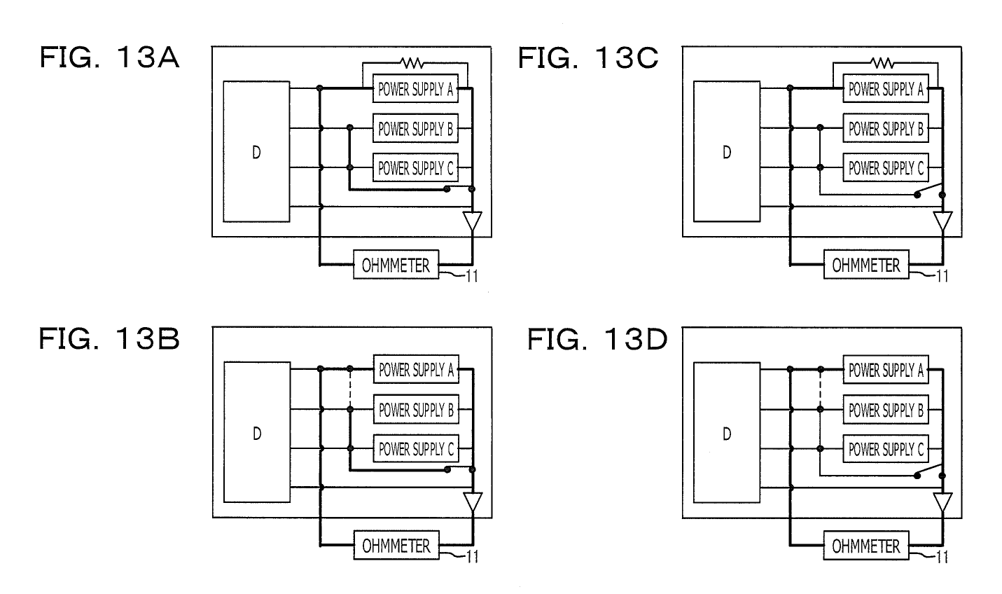

FIG. 13A to FIG. 13D illustrate an example of a defective product processing. In FIG. 13A, a short circuit between V and G has occurred in the power supply A. In FIG. 13B, a short circuit has occurred between the power supply line of the power supply A and the power supply line of the power supply B. In either of the cases illustrated in FIG. 13A and FIG. 13B, the power supply line of the power supply A and the ground is short-circuited after the power supply line of the power supply B and the power supply line of the power supply C are short-circuited. In this case, even if the resistance between V and G on the power supply line of the power supply A is measured, it may be difficult to determine whether a short circuit between V and G has occurred or a short circuit between V and V has occurred.

As the power supply lines other than the power supply line to be measured are disconnected from the ground, it is determined whether a short circuit between V and G has occurred or a short circuit between V and V has occurred. As illustrated in FIG. 13C, in a case of a short circuit between V and G, even if the ground is disconnected, the resistance value between V and G does not change. As illustrated in FIG. 13D, in a case of a short circuit between V and V, the resistance value between V and G increases. Thus, if an amount of change in the resistance value between V and G when the ground is disconnected is equal to or less than a first threshold value, it may be determined that a short circuit between V and G has occurred on the power supply line to be measured. If the amount of change (increase) in the resistance value between V and G when the ground is disconnected is greater than a second threshold value that is equal to or greater than the first threshold value, it may be determined that a short circuit between V and V has occurred of the power supply line to be measured and another power supply line.

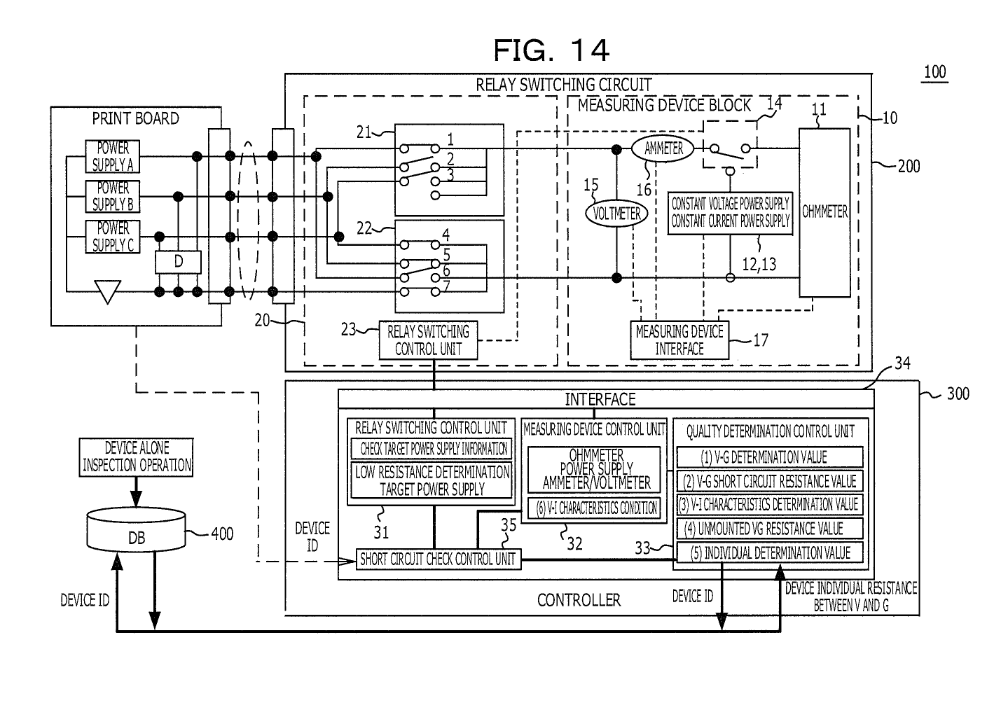

FIG. 14 illustrates an example of a measuring apparatus. The measuring apparatus illustrated in FIG. 14 may implement the measuring method illustrated in FIG. 2A to FIG. 5B and the measuring method illustrated in FIG. 11. The measuring method may be implemented automatically. The measuring apparatus 100 illustrated in FIG. 14 includes a short circuit check device 200 and a controller 300. The short circuit check device 200 includes a measuring device block 10 and a relay switching circuit 20. The measuring device block 10 includes the ohmmeter 11, the direct current constant current source 12, the direct current constant voltage source 13, the switch 14, the voltmeter 15, and the ammeter 16 illustrated in FIG. 7. Each component of the measuring device block 10 is coupled to the controller 300 through a measuring device interface 17.

The relay switching circuit 20 includes a power supply line switching switch 21, a ground connection switching switch 22, and a relay switching control unit 23. The power supply line switching switch 21 may be a relay switch for selecting a power supply line provided on the print board. The power supply line switching switch 21 couples one or more power supply lines to the ohmmeter 11. The ground connection switching switch 22 may be a relay switch for selecting a ground line between a power supply provided on the print board and the ground. The ground connection switching switch 22 grounds one or more power supplies. The relay switching control unit 23 controls the power supply line switching switch 21 and the ground connection switching switch 22 in accordance with an instruction of the controller 300. The measuring device block 10 measures the resistance, applies a power supply, or measures current/voltage between the power supply line selected through the power supply line switching switch 21 and the ground line selected through the ground connection switching switch 22. The measurement result is transmitted to the controller 300 through the measuring device interface 17.

The print board is coupled to the short circuit check device 200 through a cable or a relay board. Thus, on the print board, the power supply line and the ground may be pulled out to a connector terminal in order to couple the power supply line to be subjected to a power supply short circuit check on the print board and the ground to the measurement circuit of the short circuit check device 200. With regard to the power supply of a low resistance value, since an impedance of a measurement path leads to a measurement error, the connector terminal may include two wires for four-terminal measurement. There may be two wires in the mount board as well.

The controller 300 includes a relay switching control unit 31, a measuring device control unit 32, a quality determination control unit 33, an interface 34, and a short circuit check control unit 35. The relay switching control unit 31 retains information pertaining to a power supply to be checked and also retains information pertaining to a power supply to be subjected to a low resistance VG determination. The information pertaining to the power supply to be checked may include information in which each power supply, a terminal, and a relay number are associated with one another. The information pertaining to the power supply to be subjected to the low resistance VG determination may include information for identifying the power supply and the device ID. The relay switching control unit 31 transmits an instruction to the relay switching control unit 23 of the relay switching circuit 20 so as to control the power supply line switching switch 21 and the ground connection switching switch 22.

The measuring device control unit 23 retains (6) a V-I characteristics condition and also controls each of the ohmmeter 11, the direct current constant current source 12, the direct current constant voltage source 13, the switch 14, the voltmeter 15, and the ammeter 16. The quality determination control unit 33 retains (1) a V-G determination value, (2) a V-G short circuit resistance value, (3) a V-I characteristics determination value, (4) a device unmounted V-G resistance value, and (5) a device individual determination value, and determines whether or not a short circuit of a power supply on the print board is present based on the measurement result of each component of the measuring device block 10. (1) The V-G determination value is a determination value of the resistance between V and G of each power supply. (2) The V-G short circuit resistance value is a resistance value between V and G in a case in which V and G of each power supply are short-circuited. (3) The V-I characteristics determination value is a determination value in a case in which a constant current/constant voltage power supply that is smaller than the rated power supply voltage is applied. (4) is a resistance value between V and G of each power supply in a case in which a device has not been mounted. (5) The device individual determination value is a determination value of the resistance between V and G of a device.

The short circuit check control unit 35 obtains the ID of the device D mounted on the print board, and controls each of the relay switching control unit 31, the measuring device control unit 32, and the quality determination control unit 33. The resistance measurement result of each device alone is associated with a device ID and stored in a database 400.

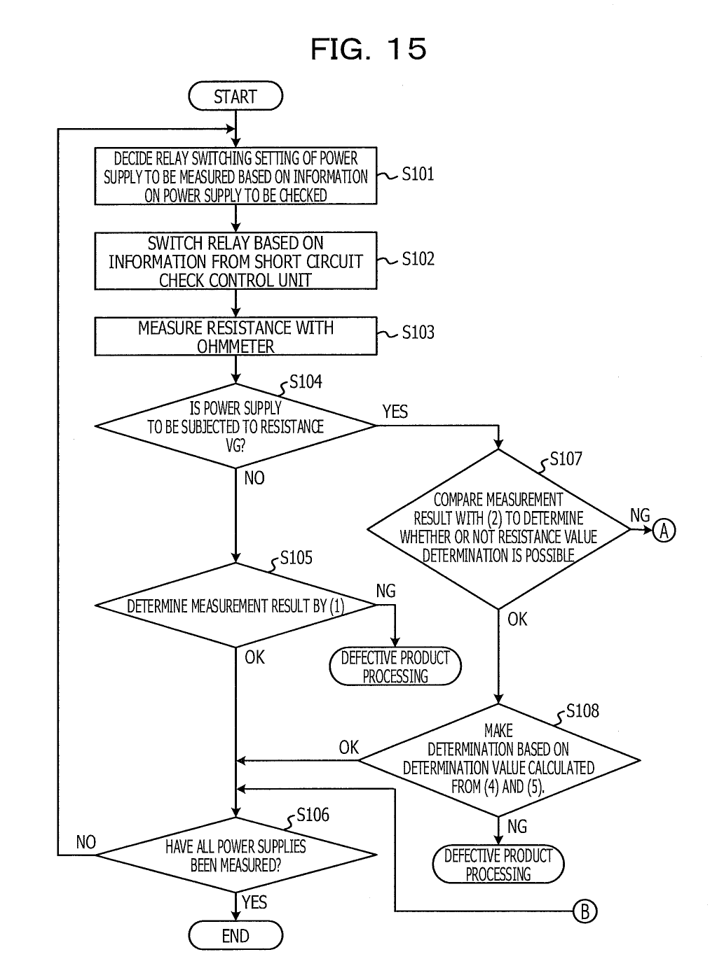

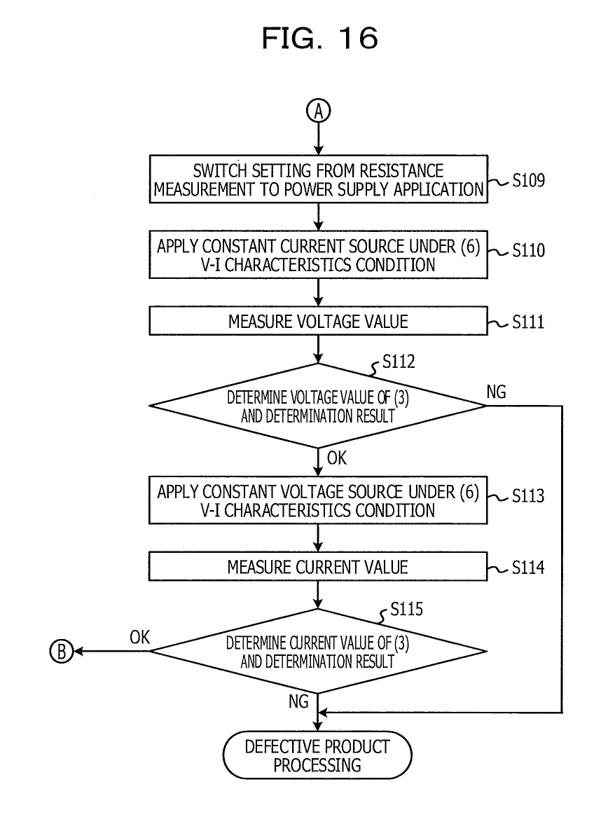

FIG. 15 and FIG. 16 illustrate an example of processing of a measuring apparatus. The processing illustrated in FIG. 15 and FIG. 16 may be carried out by the measuring apparatus 100 illustrated in FIG. 14. As illustrated in FIG. 15 and FIG. 16, the short circuit check control unit 35 decides a relay switching setting of the power supply to be measured based on the information on the power supply to be checked (operation S101). The relay switching control unit 31 switches the relay in accordance with the information from the short circuit check control unit 35 (operation S102). The power supply to be measured is short-circuited with the ground after all of the power supply lines that are not to be measured are short-circuited. For example, in a case in which the power supply A is to be measured, relays 1, 4, 5, and 7 are short-circuited, relays 2, 3, and 6 are released, and the switch 14 selects the ohmmeter 11.

The measuring device control unit 32 obtains the measured resistance by using the ohmmeter 11 (operation S103). The short circuit check control unit 35 determines whether or not the power supply is to be subjected to the low resistance VG determination based on the measurement result in operation S103 (operation S104). The determination in operation S104 is made based on whether or not the leakage current is equal to or greater than a threshold value. If it is determined to be “No” in operation S104, the quality determination control unit 33 determines whether or not the measured resistance in operation S103 is equal to or greater than (1) the V-G determination value (operation S105).

If it is determined to be “Yes” in operation S105, the short circuit check control unit 35 determines whether or not all of the power supplies have been measured (operation S106). If it is determined to be “No” in operation S106, the processing is carried out again, starting from operation S101. If it is determined to be “Yes” in operation S106, the processing is terminated. If it is determined to be “No” in operation S105, the defective product processing is carried out.

If it is determined to be “Yes” in operation S104, the quality determination control unit 33 compares the measurement result in operation S103 with (2) the V-G short circuit resistance value so as to determine whether or not the resistance value determination is possible (operation S107). For example, if the measurement result is equal to or greater than (2) the V-G short circuit resistance value, it is determined that the resistance value determination is possible. If it is determined to be “Yes” in operation S107, the quality determination control unit 33 makes a determination based on a determination value calculated from (4) the unmounted VG resistance value and (5) the individual determination value. In operation S108, if the measurement result in operation S103 is less than the determination value, the defective product processing is carried out. In operation S108, if the measurement result in operation S103 is equal to or greater than the determination value, operation S106 is carried out.

If it is determined to be “No” in operation S107, the relay switching control unit 31 switches the setting from the resistance measurement to the power supply application (operation S109). For example, the relay switching control unit 31 selects one of the direct current constant current source 12 and the direct current constant voltage source 13 with the switch 14. The measuring device control unit 32 causes the direct current constant current source 12 to supply a constant current under (6) the V-I characteristics condition (operation S110). The measuring device control unit 32 obtains the voltage from the voltmeter 15 (operation S111).

The quality determination control unit 33 determines the measured voltage obtained in operation S111 by using the voltage determination value of (3) the V-I characteristics determination value (operation S112). In operation S112, if the measured voltage is less than the voltage determination value, the defective product processing is carried out. In operation S112, if the measured voltage is equal to or greater than the voltage determination value, the measuring device control unit 32 causes the direct current constant voltage source 13 to supply a constant voltage under (6) the V-I characteristics condition (operation S113). The measuring device control unit 32 obtains the current from the ammeter 16 (operation S114). The quality determination control unit 33 determines whether or not the current obtained in operation S114 is equal to or greater than the current determination value of (3) the V-I characteristics determination value (operation S115). If it is determined to be “Yes” in operation S115, the defective product processing is carried out. If it is determined to be “No” in operation S115, operation S106 is carried out.

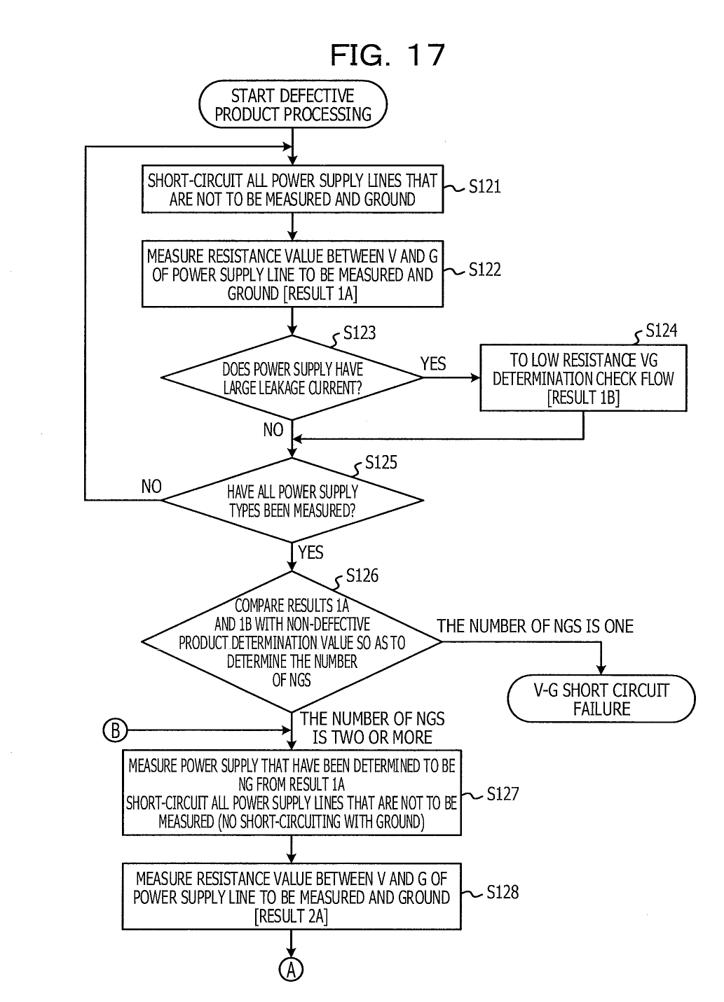

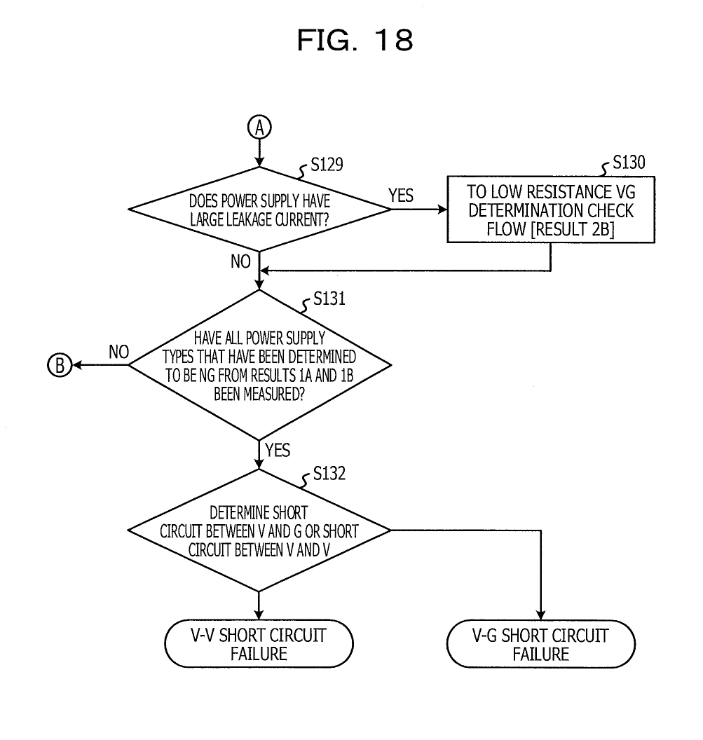

FIG. 17 and FIG. 18 illustrate an example of a defective product processing. As illustrated in FIG. 17 and FIG. 18, the relay switching control unit 31 short-circuits all of the power supply lines that are not to be measured with the ground (operation S121). The measuring device control unit 32 obtains the V-G resistance value between the power supply line to be measured and the ground (operation S122). The result obtained in operation S122 may be referred to as a result 1A. The quality determination control unit 33 determines whether or not the leakage current is large (operation S123). If it is determined to be “Yes” in operation S123, the low resistance VG determination check illustrated in FIG. 10 is carried out (operation S124). The result obtained in operation S124 is referred to as a result 1B.

If it is determined to be “No” in operation S123 or after operation S124 is carried out, the quality determination control unit 33 determines whether or not all of the power supplies have been measured (operation S125). If it is determined to be “No” in operation S125, the processing is carried out again, starting from operation S121. If it is determined to be “Yes” in operation S125, the quality determination control unit 33 compares the result 1A and the result 1B with the non-defective product determination value so as to determine the number of NGs (operation S126). The number of NGs may be the number of portions where it is determined that a short circuit of the power supply is present.

If it is determined in operation S126 that the number of NGs is one, the quality determination control unit 33 may make a determination of V-G short circuit failure. If it is determined in operation S126 that the number of NGs is two or more, the measuring device control unit 32 obtains the resistance between V and G of the power supply that has been determined to be NG from the result 1A. The relay switching control unit 31 short-circuits all of the power supply lines that are not to be measured and disconnects the stated power supply lines from the ground (operation S127). The measuring device control unit 32 obtains the V-G resistance value between the power supply line to be measured and the ground (operation S128). The result obtained in operation S128 may be referred to as a result 2A. The quality determination control unit 33 determines whether or not the leakage current is large (operation S129).

If it is determined to be “Yes” in operation S129, the low resistance VG determination check flow is carried out (operation S130). The result obtained in operation S130 may be referred to as a result 2B. If it is determined to be “No” in operation S129, or after operation S130 is carried out, the quality determination control unit 33 determines whether or not all of the power supplies that have been determined to be NG from the result 1A and the result 1B have been measured (operation S131). If it is determined to be “No” in operation S131, the processing is carried out again, starting from operation S127.

If it is determined to be “Yes” in operation S131, the determination is made on a short circuit between V and G or a short circuit between V and V based on all of the obtained results (operation S132). For example, if the result 1A is less than the result 2A, or if a short circuit of the power supply is not present in the result 2B, the quality determination control unit 33 makes a determination of V-V short circuit failure. If the result 1A is substantially equal to the result 2A, or if a short circuit of the power supply is present in the result 2B, the quality determination control unit 33 makes a determination of V-G short circuit failure.

When a short circuit check is carried out on a specific power supply line mounted on a print board by using the above-described measuring apparatus 100, the specific power supply line and the ground are short-circuited after the other power supply lines are short-circuited. Thus, a short circuit check between V and G and a short circuit check between V and V may be carried out in a fewer operations. The power supply short circuit check may be carried out with ease. Even in a case in which the resistance value between v and G of a device mounted on a print board is small and varies among devices, the power supply short circuit check may be carried out in a stable manner. The defective product processing operations may make it possible to determine a short circuit between V and G and a short circuit between V and V.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A measuring apparatus, comprising:
a switch configured to short-circuit, among a plurality of power supply lines on a print board, second power supply lines other than a first power supply line to be measured and short-circuit with a ground; and
an ohmmeter configured to measure a first resistance value between the first power supply line and the ground.

2. The measuring apparatus according to claim 1, further comprising:
a determination unit configured to determine that a short circuit has occurred if the first resistance value is less than a determination value.

3. The measuring apparatus according to claim 2,
wherein, in a case in which the determination unit has determined that a short circuit has occurred, the switch releases a short circuit between the second power supply lines and the ground, and
wherein the ohmmeter remeasures a second resistance value between the first power supply line and the ground.

4. The measuring apparatus according to claim 3,
wherein the determination unit determines that a short circuit has occurred between the first power supply line and the ground if an amount of a change between the first resistance value and the second resistance value is equal to or less than a first threshold value.

5. The measuring apparatus according to claim 4,
wherein the determination unit determines that a short circuit has occurred between the first power supply line and one of the second power supply line if an amount of a change between the first resistance value and the second resistance value is greater than a second threshold value that is equal to or greater than the first threshold value.

6. The measuring apparatus according to claim 2,
wherein, in a case in which a device is provided on the first power supply line, the determination value is calculated based on a third resistance value of the device.

7. The measuring apparatus according to claim 2,
wherein, in a case in which a device is provided on the first power supply line, the determination unit determines that a short circuit of the first power supply line has occurred based on a current value obtained when a direct voltage power supply is supplied between two points including one point between the power supply and the device and another point between the power supply and the device and a voltage value obtained when a direct current power supply is supplied between the two points.

8. A measuring method, comprising:
short-circuiting, among a plurality of power supply lines on a print board, second power supply lines other than a first power supply line to be measured with one another and short-circuiting with a ground; and
measuring a first resistance value between the first power supply line and the ground.

9. The measuring method according to claim 8, further comprising:
determining that a short circuit has occurred if the first resistance value is less than a determination value.

10. The measuring method according to claim 9, further comprising:
releasing, when determining that a short circuit has occurred, a short circuit between the second power supply lines and the ground; and
remeasuring a second resistance value between the first power supply line and the ground.

11. The measuring method according to claim 10, further comprising:
determining that a short circuit has occurred between the first power supply line and the ground if an amount of a change between the first resistance value and the second resistance value is equal to or less than a first threshold value.

12. The measuring method according to claim 11, further comprising:
determining that a short circuit has occurred between the first power supply line and one of the second power supply line if an amount of a change between the first resistance value and the second resistance value is greater than a second threshold value that is equal to or greater than the first threshold value.

13. The measuring method according to claim 9,
wherein, in a case in which a device is provided on the first power supply line, the determination value is calculated based on a third resistance value of the device.

14. The measuring method according to claim 9, further comprising:
determining, in a case in which a device is provided on the first power supply line, that a short circuit of the first power supply line has occurred based on a current value obtained when a direct voltage power supply is supplied between two points including one point between the power supply and the device and another point between the power supply and the device and a voltage value obtained when a direct current power supply is supplied between the two points.

15. A measuring system, comprising:
a print board;
a measuring apparatus configured to measure, among a plurality of power supply lines on the print board, at least one power supply line to be measured; and
a controller configured to control the measuring apparatus,
wherein the measuring apparatus includes:
a switch configured to short-circuit, among the plurality of power supply lines on a print board, second power supply lines other than a first power supply line to be measured and short-circuit with a ground; and
an ohmmeter configured to measure a first resistance value between the first power supply line and the ground.

16. The measuring system according to claim 15, further comprising:
a determination unit configured to determine that a short circuit has occurred if the first resistance value is less than a determination value.

17. The measuring system according to claim 16,
wherein, in a case in which the determination unit has determined that a short circuit has occurred, the switch releases a short circuit between the second power supply lines and the ground, and
wherein the ohmmeter remeasures a second resistance value between the first power supply line and the ground.

18. The measuring system according to claim 17,
wherein the determination unit determines that a short circuit has occurred between the first power supply line and the ground if an amount of a change between the first resistance value and the second resistance value is equal to or less than a first threshold value.

19. The measuring system according to claim 18,
wherein the determination unit determines that a short circuit has occurred between the first power supply line and one of the second power supply line if an amount of a change between the first resistance value and the second resistance value is greater than a second threshold value that is equal to or greater than the first threshold value.

20. The measuring system according to claim 16,
wherein, in a case in which a device is provided on the first power supply line, the determination value is calculated based on a third resistance value of the device.
